(19) United States
(12) Patent Application Publication
(10) Pub. No.: US 2005/0169787 A1
(43) Pub. Date: Aug. 4, 2005

(54) Compressor

(76) Inventors: Masao Iguchi, Kariya-shi (JP); Kazuya Kimura, Kariya-shi (JP); Izuru Shimizu, Kariya-shi (JP); Susumu Tarao, Kariya-shi (JP); Akihiro Kawakami, Kariya-shi (JP)

Correspondence Address: MORGAN & FINNEGAN, L.L.P., 3 World Financial Center, New York, NY, 10281-2101, US

(21) Appl. No.: 11/031,597

(22) Filed: Jan. 6, 2005

(30) Foreign Application Priority Data
Jan. 14, 2004 (JP) 2004-007129

(51) Int. Cl. F01C 1/02; F04C 18/00; F01C 1/063; F03C 4/00

(52) U.S. Cl. 418/55.5; 418/55.1

(57) ABSTRACT

A compressor has a housing, a compression mechanism and a partition member. The housing defines therein a discharge chamber. The compression mechanism is located adjacent to the discharge chamber in the housing. The partition member faces a predetermined region, which is a portion of the compression mechanism that faces the discharge chamber except a specific region where a gas discharge port opens, for restraining pressure of refrigerant gas in the discharge chamber to be applied to the predetermined region.

### BACKGROUND OF THE INVENTION

The present invention relates to a compressor, for example, for use in a vehicle air conditioner.

For example, a motor compressor, which accommodates an electric motor and a scroll type compression mechanism in a housing thereof, discharges refrigerant gas through a discharge port, which is formed in a fixed scroll member of the compression mechanism, to a discharge chamber. There are various kinds of conventional structures of the discharge chamber in the housing.

As disclosed in FIG. 5 of Unexamined Japanese Patent Publication No. 62-142801, a discharge chamber is defined by a back surface of a fixed scroll member, an annular peripheral wall, which is provided on the periphery of the fixed scroll member, and a flat plate, which is fixed to the peripheral wall by bolts at a certain distance from the back surface of the fixed scroll member.

Also, as disclosed in FIGS. 1 and 5 of Unexamined Utility Model Publication No. 1-144484, a discharge chamber is defined by a peripheral wall of a fixed scroll member and substantially a cylindrical cover having an opening at one end, which is fixed to a peripheral groove recessed along the distal end of the peripheral wall. Furthermore, as disclosed in FIG. 3 of Unexamined Japanese Patent Publication No. 5-256272, a discharge chamber is defined by a peripheral wall of a fixed scroll member and a cylindrical cover having an opening at one end and fixed to the distal end of the peripheral wall by bolts.

In a compressor that employs carbon dioxide as refrigerant gas, the maximum pressure of the compressor is approximately ten times as high as that of a compressor that employs fluorocarbon gas. For the reason, a pressure difference of the refrigerant gas between an outermost compression chamber of a scroll type compression mechanism and a discharge chamber may cause an annular portion, that is, the back surface of the fixed scroll member except the center thereof, to deform toward a movable scroll member. If the fixed scroll member deforms, each scroll wall of the scroll member needs a larger clearance between each distal end, thus decreasing the compression efficiency of the compression mechanism. Additionally, since each distal end of the scroll wall of the scroll member is pressed against the facing scroll member by the deformation of the fixed scroll member, each scroll wall needs to increase in strength.

To prevent such deformation of the fixed scroll member, the discharge chamber may be reduced in volume so as to face only the center of the fixed scroll member. Accordingly, the pressure of the refrigerant gas is not applied to the fixed scroll member on the outer peripheral side of the compression chamber, thus preventing the deformation of the fixed scroll member. However, as the discharge chamber is reduced in volume, the refrigerant gas discharged from the scroll type compression mechanism to the discharge chamber increases in pulsation. Additionally, when the refrigerant gas employs carbon dioxide, the pulsation of the refrigerant gas is distinct because the maximum pressure of the refrigerant gas is huge.

As the discharge camber is formed to face only the center of the fixed scroll member while ensuring the volume thereof, the discharge chamber needs to be elongated in the axial direction of the fixed scroll member, or the discharge chamber needs to be reduced in the radially cross-sectional area on the side adjacent to the fixed scroll member while being increased in the radially cross-sectional area at a position away from the fixed scroll member. Thus, the housing should be enlarged, thereby enlarging the compressor.

It is not only occurred to the scroll type compression mechanism, but there also is a problem in a compressor having a piston type compression mechanism that the above mentioned pressure difference causes deformation of a valve plate that is provided to isolate the compression chamber from the discharge chamber. As the valve plate is thickened for preventing the deformation thereof, the volume of the discharge chamber is limited, the housing of the compressor is enlarged, or the compressor is increased in weight. Therefore, there is a need for a compressor that prevents a compression mechanism from being deformed by high-pressure compressed refrigerant gas and that also increases the volume of a discharge chamber without enlarging the housing thereof.

### SUMMARY OF THE INVENTION

In accordance with the present invention, a compressor has a housing, a compression mechanism and a partition member. The housing defines therein a discharge chamber. The compression mechanism is located adjacent to the discharge chamber in the housing. The partition member faces a predetermined region, which is a portion of the compression mechanism that faces the discharge chamber except a specific region where a gas discharge port opens, for restraining pressure of refrigerant gas in the discharge chamber to be applied to the predetermined region.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a longitudinal cross-sectional view of a motor compressor according to a first preferred embodiment of the present invention;

FIG. 2 is a partially cross-sectional view of the motor compressor according to the first preferred embodiment of the present invention;

FIG. 3 is a perspective view illustrating a partition member;

FIG. 4 is a longitudinal cross-sectional view of a motor compressor according to a second preferred embodiment of the present invention;

FIG. 5 is a partially longitudinal cross-sectional view of the motor compressor according to the second preferred embodiment of the present invention;

FIG. 6 is a perspective view illustrating a discharge gas casing according to the second preferred embodiment of the present invention;

FIG. 7 is a longitudinal cross-sectional view illustrating a portion around a communicating tube according to the second preferred embodiment of the present invention; and

FIG. 8 is a longitudinal cross-sectional view of a compressor according to an alternative embodiment of the present invention.

### DETAILED DESCRIPTION OF THE PREFERRED EMBODIMENTS

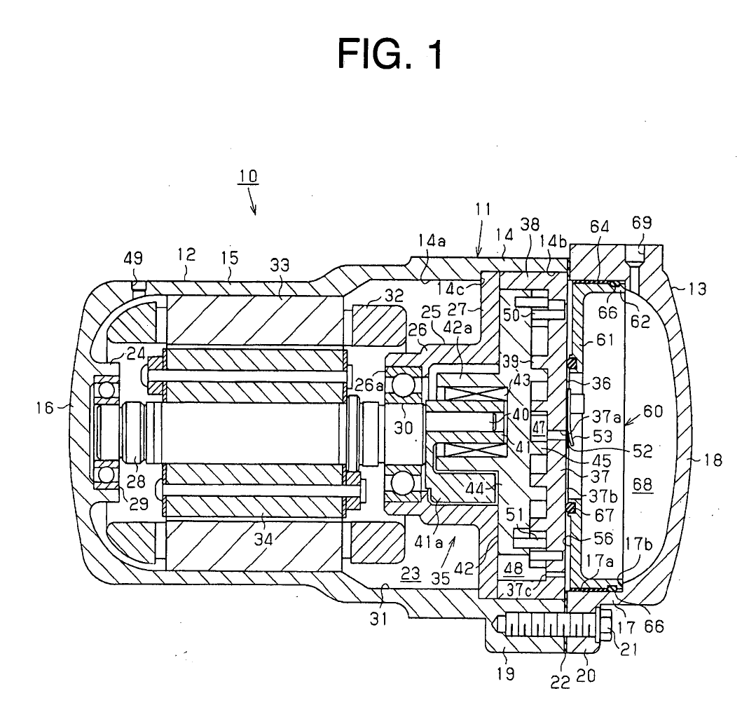

A first preferred embodiment of a scroll type motor compressor 10 for use in a vehicle air conditioner according to the present invention will now be described with reference to FIGS. 1 through 3.

As shown in FIG. 1, the motor compressor 10 has a housing 11 including a first housing component 12 and a second housing component 13, both of which are made of aluminum alloy die-casting and connected to each other. The first housing component 12 is formed in a deep cylindrical shape having an opening at one end, and includes a large-diameter cylindrical portion 14, a small-diameter cylindrical portion 15 and a bottom portion 16. The small-diameter cylindrical portion 15 is integrally formed at one end of the large-diameter cylindrical portion 14. The bottom portion 16 closes one end of the small-diameter portion 15. The second housing component 13 is formed in a shallow cylindrical shape having an opening at one end, and includes a cylindrical portion 17 and a bottom portion 18. The cylindrical portion 17 has substantially the same diameter as the large-diameter cylindrical portion 14. The bottom portion 18 closes one end of the cylindrical portion 17.

In the first housing component 12, a small-diameter portion 14a on the side of the small-diameter cylindrical portion 15 and a large-diameter portion 14b on the side of the opening end are formed inside the large-diameter cylindrical portion 14, and a first holding surface 14c is formed at a step therebetween. On the other hand, a second holding surface 17b is formed inside the second housing component 13 on the radially inner side relative to an inner peripheral surface 17a of the cylindrical portion 17 and on the radially inner side relative to the first holding surface 14c.

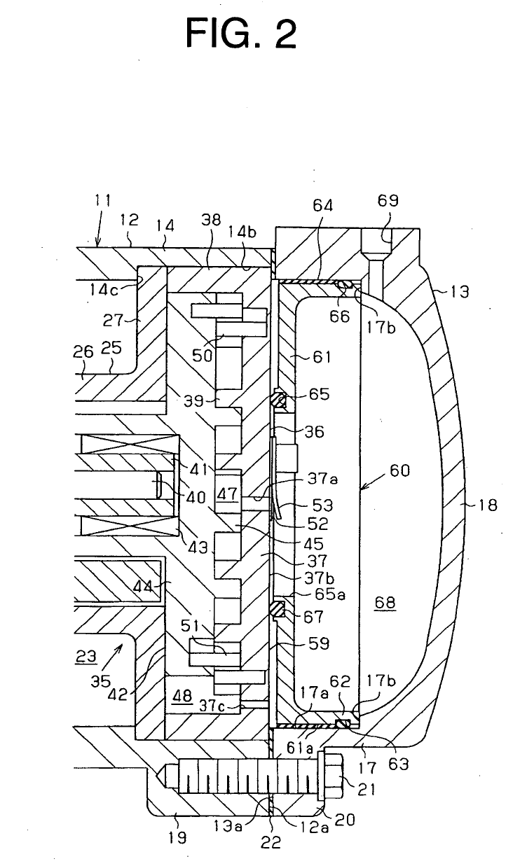

The first housing component 12 forms therein a plurality of fitting portions 19, which is integrally formed at intervals on the outer peripheral surface of the opening side of the large-diameter cylindrical portion 14. The second housing component 13 forms therein a plurality of fitting portions 20, which is integrally formed at positions that correspond to the plurality of fitting portions 19 on the outer peripheral surface of the opening side of the cylindrical portion 17. As shown in FIG. 2, the first housing component 12 and the second housing component 13 are fastened by bolts 21 at the respective fitting portions 19, 20. Additionally, the first housing component 12 has a joint surface 12a, which faces a joint surface 13a of the second housing component 13 and is press against the joint surface 13a through substantially an annular gasket 22, so that the housing 11 forms therein a closed space 23.

The inner periphery of the joint surface 13a of the second housing component 13 extends radially inward relative to the joint surface 12a of the first housing component 12. Then, the inner periphery of the joint surface 13a faces the first holding surface 14c of the first housing component 12. Also, the gasket 22 is substantially formed to the same shape as the joint surface 13a of the second housing component 13. The inner periphery of the gasket 22 also faces the first holding surface 14c of the first housing component 12.

As shown in FIG. 1, the first housing component 12 forms therein a cylindrical shaft support portion 24, which extends from the inner center portion of the bottom portion 16 of the first housing component 12. On the other hand, the first housing component 12 also accommodates a shaft support member 25, which is fitted into the large-diameter portion 14b of the large-diameter cylindrical portion 14 of first housing component 12. The shaft support member 25 includes a cylindrical portion 26 and a flange 27. The cylindrical portion 26 forms therein a through hole 26a. The flange 27 is provided at one end of the cylindrical portion 26. The shaft support member 25 is positioned in the first housing component 12 so that the outer periphery of the flange 27 is in contact with the first holding surface 14c.

The first housing component 12 accommodates therein a rotary shaft 28, which is rotatably supported at one end by the shaft support portion 24 through a bearing 29 and also rotatably supported at the other end in the through hole 26a of the shaft support member 25 through a bearing 30. A motor chamber 31 is defined between the shaft support member 25 and the bottom portion 16. A stator core 33, around which an exciting coil 32 wound, is fixedly fitted in the small-diameter cylindrical portion 15 of the first housing component 12. A rotor 34, which is made of a multipolar magnet, is fixed to the rotary shaft 28 so as to face the stator core 33. The exciting coil 32, the stator core 33, the rotor 34 and the like cooperatively form an inner rotor type electric brushless motor.

The first housing component 12 accommodates therein a scroll type compression mechanism 35 inside the large-diameter cylindrical portion 14. That is, a fixed scroll member 36 is fixedly fitted in the large-diameter portion 14b of the first housing component 12. The fixed scroll member 36 has a disc-shaped base plate 37, a cylindrical outer peripheral wall 38 and a fixed scroll wall 39. The cylindrical outer peripheral wall 38 is integrally formed on the outer periphery of the base plate 37. The fixed scroll wall 39 is integrally formed with the base plate 37 inside the outer peripheral wall 38. The distal end of the outer peripheral wall 38 of the fixed scroll member 36 is in contact with the flange 27 of the shaft support member 25, which is in contact with the first holding surface 14c of the first housing component 12.

A crankshaft 40 extends from the end surface of the rotary shaft 28 on the side of the fixed scroll member 36. A bushing 41 having a balance weight 41a is fixedly fitted around the crankshaft 40. A movable scroll member 42, which faces the fixed scroll member 36, is supported rotatably with respect to the fixed scroll member 36 by the bushing 41 through a bearing 43, which is placed in a boss 42a. The crankshaft 40, the bushing 41 and the bearing 43 cooperatively form an orbiting mechanism to orbit the movable scroll member 42 by the rotation of the rotary shaft 28.

The movable scroll member 42 has a disc-shaped base plate 44 and a movable scroll wall 45, which is integrally formed with the base plate 44. As shown in FIG. 2, the movable scroll wall 45 of the movable scroll member 42 is engaged with the fixed scroll wall 39 of the fixed scroll member 36. The distal end of the movable scroll wall 45 is in contact with the base plate 37 of the fixed scroll member 36 through a seal member (not shown). Likewise, the distal end of the fixed scroll wall 39 is in contact with the base plate 44 of the movable scroll member 42 through a seal member (not shown). Thus, the fixed scroll member 36 and the movable scroll member 42 define a compression chamber 47 adjacent to the center of the base plate 37 of the fixed scroll member 36.

The compression chamber 47 is in communication with an inner space of the second housing component 13 through a (gas) discharge hole 37a that extends through the center of the base plate 37 of the fixed scroll member 36 and opens at a back surface 37b of the base plate 37. The outer peripheral wall 38 of the fixed scroll member 36 and the outermost peripheral portion of the movable scroll wall 45 of the movable scroll member 42 define therebetween a suction chamber 48. The suction chamber 48 is in communication with the motor chamber 31 through a passage (not shown), and is connected to an evaporator of an external refrigerant circuit (not shown) through a suction port 49 (shown in FIG. 1), which is formed in the first housing component 12 for connecting the motor chamber 31 to an outside.

A plurality of fixed pins 50 are secured on the same circumference to the base plate 37 of the fixed scroll member 36, and a plurality of movable pins 51 are correspondingly secured to the base plate 44 of the movable scroll member 42 relative to the respective fixed pins 50. Then, the fixed pins 50 and the movable pins 51 cooperatively form a known self-rotation blocking mechanism for the movable scroll member 42.

A discharge valve 52 is provided at the center of the back surface 37b of the base plate 37 of the fixed scroll member 36 for opening and closing the discharge hole 37a. The opening degree of the discharge valve 52 is regulated by a retainer 53, which is fixed to the base plate 37.

The inner periphery of the gasket 22 and the inner periphery of the joint surface 13a of the second housing component 13, in this order, are in contact with the outer periphery of the back surface 37b of the base plate 37 of the fixed scroll member 36. The fixed scroll member 36, the shaft support member 25 and the gasket 22 are held between the first holding surface 14c of the first housing component 12 and the second holding surface 17b of the second housing component 13. That is, the fixed scroll member 36 is held between the gasket 22 and the shaft support member 25.

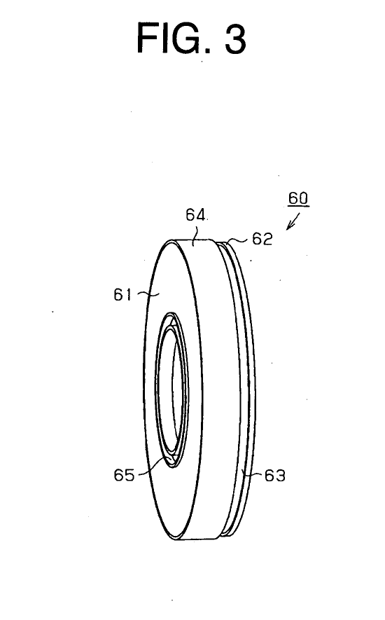

An annular partition member 60 is placed in the second housing component 13. The partition member 60 is held between the fixed scroll member 36 and the second housing component 13. As shown in FIG. 3, the partition member 60 has a disc-shaped partition wall 61 and a cylindrical peripheral wall 62 that extends from the outer periphery of the partition wall 61 in the axial direction of the partition wall 61. As shown in FIG. 2, an inner peripheral surface of the corner between the partition wall 61 and the peripheral wall 62 is circular arc in shape for connection therebetween. Thus, the partition wall 61 is improved in strength against curving deformation in the axial direction of the peripheral wall 62. It is noted that the partition member 60 is integrally manufactured by forging iron material.

As shown in FIG. 3, a peripheral groove 63 is recessed on the outer peripheral surface of the peripheral wall 62 near a side opposite to the partition wall 61. A rubber layer 64, which is a heat insulation and elastic material, is formed on the outer peripheral surface of the peripheral wall 62 at a portion from the partition wall 61 to the left end of the peripheral groove 63 in FIG. 3. Additionally, an annular groove 65 is recessed on the partition wall 61 at a side opposite to the peripheral wall 62 along the inner periphery of the partition wall 61. As shown in FIGS. 1 and 2, O-rings 66, 67 are fitted in the grooves 63, 65, respectively. In the first preferred embodiment, the rubber layer 64 and the O-ring 67 are heat insulation and elastic materials. The O-ring 66 is a first sealing member, and the O-ring 67 is a second sealing member, thereby forming a sealing member.

The peripheral wall 62 of the partition member 60 is supported through the rubber layer 64 onto the inner peripheral surface 17a of the cylindrical portion 17 of the second housing component 13. Also, the distal end of the peripheral wall 62 is in contact with the second holding surface 17b of the second housing component 13. The partition wall 61 faces an annular region (a predetermined region) of the back surface 37b of the base plate 37 of the fixed scroll member 36 (a portion that faces the discharge chamber of the compression mechanism) except the center thereof (a region where the gas discharge hole opens). At the same time, the O-ring 66 is in close contact with the inner peripheral surface 17a of the second housing component 13, while the O-ring 67 is in close contact with the back surface 37b of the base plate 37 of the fixed scroll member 36. That is, the partition member 60, the shaft support member 25 and the fixed scroll member 36 are held between the first housing component 12 and the second housing component 13. Thus, the partition member 60 is positioned in the axial direction of the rotary shaft 28.

The second housing component 13 defines therein a discharge chamber 68, with which the compression chamber 47 communicates through the discharge hole 37a of the fixed scroll member 36. The discharge chamber 68 is isolated in airtight from the annular region, that is, the back surface 37b of the base plate 37 of the fixed scroll member 36 except the center thereof, by the partition member 60 and the O-rings 66, 67. In other words, the space between the annular region, that is, the back surface 37b of the base plate 37 except the center thereof, and the partition wall 61 of the partition member 60 is isolated in airtight from the discharge chamber 68 by the gasket 22 and the O-rings 66, 67. The suction chamber 48 is in communication with the above space through a through hole 37c, which is formed in the base plate 37 of the fixed scroll member 36. On the other hand, the discharge chamber 68 is connected to a condenser of the external refrigerant circuit (not shown) through a discharge port 69, which is formed in the second housing component 13.

In the motor compressor 10 as described above, as the motor is driven, the movable scroll member 42 is orbited around the axis of the fixed scroll member 36 through the crankshaft 40 of the rotary shaft 28. Then, as the compression chamber 47 progressively reduces in volume and moves inward from the outer peripheral side of the scroll walls 39, 45 by the orbital motion of the movable scroll member 42, refrigerant gas introduced from the suction chamber 48 into the compression chamber 47 is compressed. After the compressed refrigerant gas is discharged to the discharge chamber 68 through the discharge hole 37a of the fixed scroll member 36, the refrigerant gas is supplied to the condenser of the external refrigerant circuit through the discharge port 69.

According to the first preferred embodiment of the present invention, the following advantageous effects are obtained.

(1) The partition member 60 is provided in the housing 11, in which the scroll type compression mechanism 35 and the discharge chamber 68 that is adjacent to the back surface 37b of the fixed scroll member 36, and faces the annular region, that is, the base plate 37 of the fixed scroll member 36 except the center thereof. The partition member 60 prevents the pressure of the refrigerant gas in the discharge chamber 68 from being applied to the annular region.

Therefore, the base plate 37 of the fixed scroll member 36 is hard to be deformed toward the movable scroll member 42 even by the high-pressure of the refrigerant gas in the discharge chamber 68. Accordingly, the variation of the clearances between the distal end of the fixed scroll wall 39 of the fixed scroll member 36 and the base plate 44 of the movable scroll member 42 and between the distal end of the movable scroll wall 45 of the movable scroll member 42 and the base plate 37 of the fixed scroll member 36 become small. Thus, the distal end of the scroll wall 39 (or 45) is not tightly pressed against the base plate 44 (or 37), so that excessive stress does not occur at the proximal portions of the scroll walls 39, 45 thereby improving reliability.

Additionally, the iron partition member 60, which has more strength than the aluminum alloy, is located at the side of the opening end of the aluminum alloy cylindrical second housing component 13 having a bottom at one end, and the partition member 60 prevents the pressure of the refrigerant gas in the discharge chamber 68 from being applied to the annular region, that is, the back surface 37b of the base plate 37 of the fixed scroll member 36 except the center thereof. Accordingly, the thickness of the partition member 60 may be thinned unlike in the case of the partition member 60 integrally formed with the second housing component 13, so that limitations on the volume of the discharge chamber 68 is reduced.

Consequently, the compression mechanism 35 is prevented from being deformed due to the high-pressure compressed refrigerant gas, and the volume of the discharge chamber 68 may be increased without enlarging the housing 11.

The iron partition member 60, which has a lower thermal conductivity than aluminum alloy and the air layer between the partition member 60 and the base plate 37 of the fixed scroll member 36, reduces heat transmitted from the refrigerant gas in the discharge chamber 68 to the refrigerant gas in the suction chamber 48 through the fixed scroll member 36. Thus, the refrigerant gas in the suction chamber 48 is prevented from decreasing in density, and the compression efficiency of the compression mechanism 35 is improved.

(2) The partition member 60 is integrally composed of the cylindrical partition wall 61 and the cylindrical peripheral wall 62 that extends from the outer periphery of the partition wall 61 in the axial direction thereof. Then, the partition wall 61 faces the annular region, that is, the back surface 37b of the fixed scroll member 36 except the center thereof, and the peripheral wall 62 is inserted in the inner peripheral surface 17a of the second housing component 13 and supported thereon.

Therefore, as the partition member 60 is accommodated in the housing 11, the conventional housing may basically be employed. Furthermore, as the cylindrical peripheral wall 62 that extends from the outer periphery of the partition wall 61 in the axial direction thereof is inserted in the housing 11 and supported thereon, the partition wall 61 is improved in strength against deformation in the axial direction thereof in comparison to a structure that the outer periphery of the partition member formed merely in a disc-shape is supported in the housing 11. Thus, the base plate 37 of the fixed scroll member 36 is further efficiently prevented from being deformed.

(3) Since the rubber layer 64 is provided as the insulation material between the peripheral wall 62 of the partition member 60 and the second housing component 13, it reduces heat transmitted from the refrigerant gas in the discharge chamber 68 to the refrigerant gas in the suction chamber 48 and the motor chamber 31 through the partition member 60, the second housing component 13 and the first housing component 12. Thus, the refrigerant gas in the suction chamber 48 is prevented from decreasing in density, and the compression efficiency of the compression mechanism 35 is further improved.

Additionally, since the O-ring 67 is interposed between the partition member 60 and the base plate 37 of the fixed scroll member 36, it reduces heat transmitted from the partition member 60 to the fixed scroll member 36, thus further improving the compression efficiency of the compression mechanism 35.

(4) The partition member 60 is elastically supported on the housing 11 by the rubber layer 64, which is interposed between the peripheral wall 62 of the partition member 60 and the second housing component 13. Thus, noise or vibration of the compressor 10 due to pulsation of the refrigerant gas discharged from the compression chamber 47 to the discharge chamber 68 is reduced.

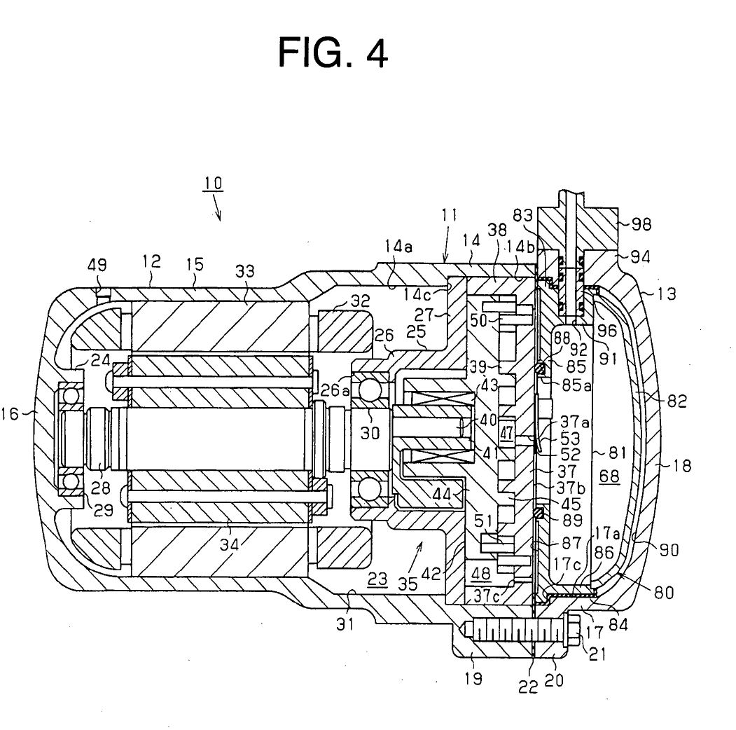

A second preferred embodiment of the scroll type motor compressor 10 that is similar to that of the first preferred embodiment according to the present invention will now be described with reference to FIGS. 4 through 7. The same reference numerals denote the substantially same components to those in the first preferred embodiment, and the description is omitted. The components different from those in the first preferred embodiment will only be described.

A third holding surface 17c, instead of the second holding surface 17b in the first preferred embodiment, is provided in the second housing component 13 according to the second preferred embodiment. The third holding surface 17c is formed near the opening end of the cylindrical portion 17 so as to face the first holding surface 14c of the first housing component 12.

The joint surface 13a of the second housing component 13 does not extend radially inward relative to the joint surface 12a of the first housing component 12, which is different from the first preferred embodiment. However, the inner periphery of the gasket 22 extends radially inward relative to the joint surfaces 12a, 13a. Then, the inner periphery of the gasket 22 is in contact with the outer periphery of the back surface 37b of the base plate 37 of the fixed scroll member 36.

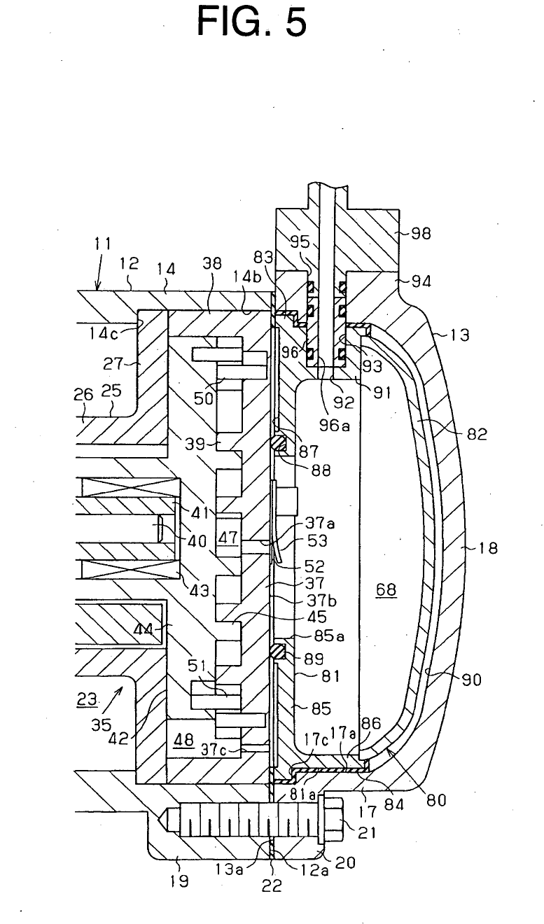

A discharge gas casing 80, which forms the discharge chamber 68, is located in the second housing component 13. The discharge gas casing 80, as shown in FIGS. 5 and 6, includes an annular partition member 81 and substantially a semicircular cover portion 82 (a member for forming the discharge chamber 68), which closes one end of the partition member 81. The partition member 81 is supported by the housing 11 so as to face the annular region, that is, the back surface 37b of the base plate 37 of the fixed scroll member 36 except the center thereof. The partition member 81 is integrally formed by forging iron material. Also, the cover portion 82 is integrally formed by pressing iron plate material. The partition member 81 and the cover portion 82 are welded with each other. A welding method may employ fusion welding, such as metal active gas arc welding (or MAG welding) and laser welding, and pressure welding, such as resistance welding and friction welding.

The partition member 81 includes a flange 83 near the fixed scroll member 36 so as to extend outward. The partition member 81 is covered with a rubber layer 84, which functions as a heat insulation and elastic material, on its outer peripheral surface 81 a including the flange 83.

The partition member 81 is integrally composed of a disc-shaped partition wall 85 and a cylindrical peripheral wall 86 that extends from the outer periphery of the partition wall 85 in the axial direction of the partition wall 85. The inner peripheral surface of the corner between the partition wall 85 and the peripheral wall 86 forms a circular arc in shape, thus enhancing the strength against bending of the partition wall 85 in the axial direction of the peripheral wall 86. It is noted that the partition member 81 is integrally formed by forging iron material.

An annular recess 87 is formed around the opening 85a of the partition wall 85 and on an end surface of the partition wall 85, which is opposite to the peripheral wall 86 in the partition wall 85 of the partition member 81. An annular groove 88 is formed along the inner periphery of the partition wall 85 on the end surface of the partition wall 85, which is opposite to the peripheral wall 86. An O-ring 89 is fitted into the annular groove 88. In the second preferred embodiment, the O-ring 89 functions as a sealing member.

The peripheral wall 86 of the discharge gas casing 80 is inserted and supported through the rubber layer 84 on the inner peripheral surface 17a of the cylindrical portion 17 of the second housing component 13. Also, the flange 83 of the partition member 81 is in contact with the third holding surface 17c through the rubber layer 84. The partition wall 85 faces an annular region (a predetermined region), that is, the back surface 37b of the base plate 37 (a portion) of the fixed scroll member 36 except the center (a specific region) thereof. At this time, the O-ring 89 is in close contact with the back surface 37b of the base plate 37 of the fixed scroll member 36. Additionally, the inner periphery of the gasket 22 is interposed between the flange 83 of the partition member 81 and the outer periphery of the back surface 37b of the base plate 37 of the fixed scroll member 36. That is, the discharge gas casing 80, the shaft support member 25 and the fixed scroll member 36 are held between the first holding surface 14c of the first housing component 12 and the third holding surface 17c of the second housing component 13. Thus, the discharge gas casing 80 is positioned in the axial direction of the rotary shaft 28.

The discharge chamber 68, which is defined in the discharge gas casing 80, is isolated inside the second housing component 13 by the cover portion 82, which is connected to the partition member 81. Then, the discharge chamber 68 is partitioned in airtight from the annular region, that is, the back surface 37b of the base plate 37 of the fixed scroll member 36 except the center thereof, by the partition member 81 and the O-ring 89. In other words, the space between the annular region, that is, the back surface 37b of the base plate 37 except the center thereof, and the partition wall 85 of the partition member 81 is isolated in airtight from the discharge chamber 68 by the gasket 22 and the O-ring 89. This space is in communication with the suction chamber 48 through the through hole 37c, which is formed in the base plate 37 of the fixed scroll member 36.

As shown in FIGS. 4 and 5, a gap or a heat insulation means 90 having substantially similarly spacing is formed between the outer surface of the cover portion 82 and the inner surface of the bottom portion 18 of the second housing component 13. This gap 90 is provided for insulating heat transmission between the second housing component 13 and the cover portion 82.

As shown in FIG. 5, the peripheral wall 86 of the partition member 81 of the discharge gas casing 80 forms therein an internal seat 91 at a portion in the circumferential direction of the peripheral wall 86, and this internal seat 91 forms therein a communication hole 92 for communication between the discharge chamber 68 and the outside. The internal seat 91 forms therein an internal fitting hole 93 that communicates with the communication hole 92 and opens to the outer peripheral surface of the partition member 81. On the other hand, the second housing component 13 forms therein an external seat 94, which is located at a portion that corresponds to the internal seat 91, and this external seat 94 forms therein an external fitting hole 95 that conforms with the internal fitting hole 93.

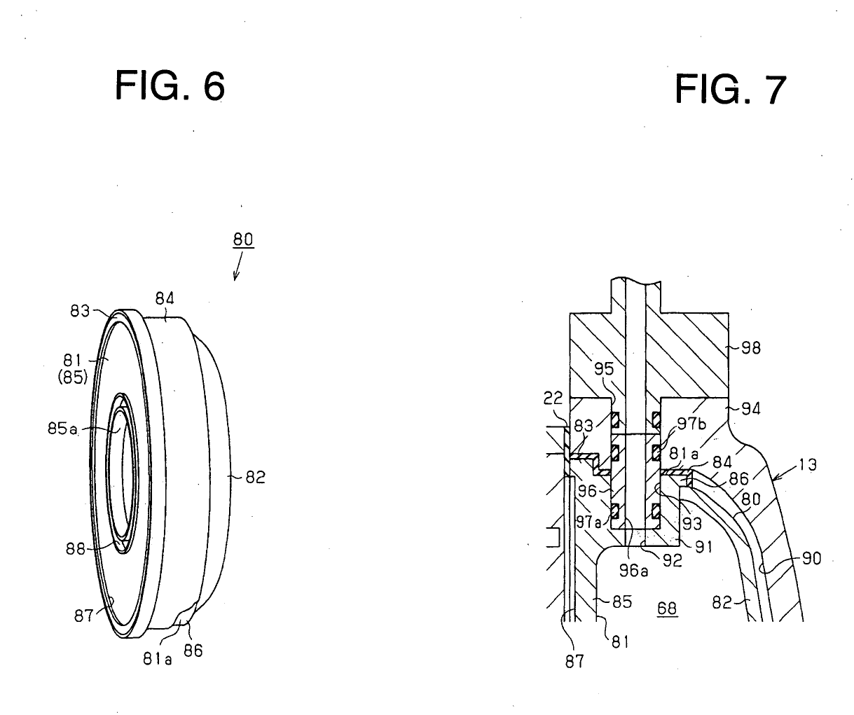

As shown in FIG. 7, a communicating tube 96 is inserted in both the internal fitting hole 93 of the internal seat 91 and the external fitting hole 95 of the external seat 94 for forming a passage that communicates with the communication hole 92 of the internal seat 91. The communicating tube 96 forms therein an internal passage 96a that is isolated in airtight from the boundary surface between the second housing component 13 and the discharge gas casing 80 by O-rings 97a, 97b, which are respectively interposed between the communicating tube 96 and the inner peripheral surface of the internal fitting hole 93 and between the communicating tube 96 and the inner peripheral surface of the external fitting hole 95, while it is in communication with the communication hole 92 of the internal seat 91. Also, a coupling 98 of a conduit that is connected to the condenser of the external refrigerant circuit (not shown) is connected to the external fitting hole 95 of the external seat 94. In the second preferred embodiment, the communicating tube 96 and the O-rings 97a, 97b function as communicating means.

In the above described motor compressor 10, the refrigerant gas discharged from the compression chamber 47 to the discharge chamber 68 in the discharge gas casing 80 through the discharge hole 37a is supplied to the condenser of the external refrigerant circuit through the communication hole 92 of the internal seat 91 and the internal passage 96a of the communicating tube 96.

According to the second preferred embodiment, in addition to the paragraph (1) through (4) mentioned in the first preferred embodiment, the following advantageous effects are obtained.

(5) The partition member 81 that corresponds to the partition member 60 of the first preferred embodiment includes the cover portion 82, which isolates the discharge chamber 68 inside the second housing component 13. Then, the refrigerant gas is discharged outside the housing 11 from the discharge chamber 68 through the communicating tube 96, which is sealed against the boundary surface between the discharge gas casing 80 and the second housing component 13. The gap 90 having substantially the same spacing is formed as a heat insulation space between the cover portion 82 and the second housing component 13. Therefore, heat transmitted from the refrigerant gas in the discharge chamber 68 to the refrigerant gas in the suction chamber 48 and the motor chamber 31 through the second housing component 13 and the first housing component 12 is reduced. Accordingly, the refrigerant gas in the suction chamber 48 is prevented from decreasing in density, thereby further enhancing compression efficiency of the compression mechanism 35.

Furthermore, since the cover portion 82 is made of iron material that has a higher strength than aluminum alloy, the thickness of the second housing component 13 may be thinned in comparison to the structure in which the second housing component 13 directly forms therein the discharge chamber 68 as in the first preferred embodiment. Therefore, the same volume discharge chamber 68 is obtained by the housing 11 having a smaller size. Additionally, the cover portion 82 made of iron material that has a lower thermal conductivity than aluminum alloy reduces heat transmitted from the refrigerant gas in the discharge chamber 68 to the second housing component 13 through the cover portion 82.

The present invention is not limited to the embodiments described above but may be modified into the following alternative embodiments.

In an alternative embodiment to the first preferred embodiment, the partition member 60 is made of other metal materials, such as magnesium alloy, titanium alloy. Additionally, the partition member 60 may be made of non-metallic materials. This may also be applied to the partition member 81 and the cover portion 82 of the discharge gas casing 80 in the second preferred embodiment.

In an alternative embodiment to the second preferred embodiment, a rubber layer or an insulation means occupies the gap between the cover portion 82 of the discharge gas casing 80 and the bottom portion 18 of the second housing component 13. The rubber layer may be inserted in a fluid state into the gap between the discharge gas casing 80 and the second housing component 13 during assembling of the compressor 10, or may previously be applied on outer surface of the cover portion 82 of the discharge gas casing 80 or the inner surface of the bottom portion 18 of the second housing component 13.

In an alternative embodiment to the first preferred embodiment, the housing 11 includes a first housing component which accommodates a motor, and a second housing component, which includes a shaft support member that supports one end of a rotary shaft and is formed to accommodate a compression mechanism, the partition member 81 and the discharge chamber 68. This may also be applied to the second preferred embodiment.

In an alternative embodiment to the first preferred embodiment, a partition member is a disc-shaped partition wall member that faces a back surface of the fixed scroll member except the center thereof, and is held between the first housing component 12 and the second housing component 13.

The present invention may be applied to a motor compressor that employs fluorocarbon series refrigerant as refrigerant gas.

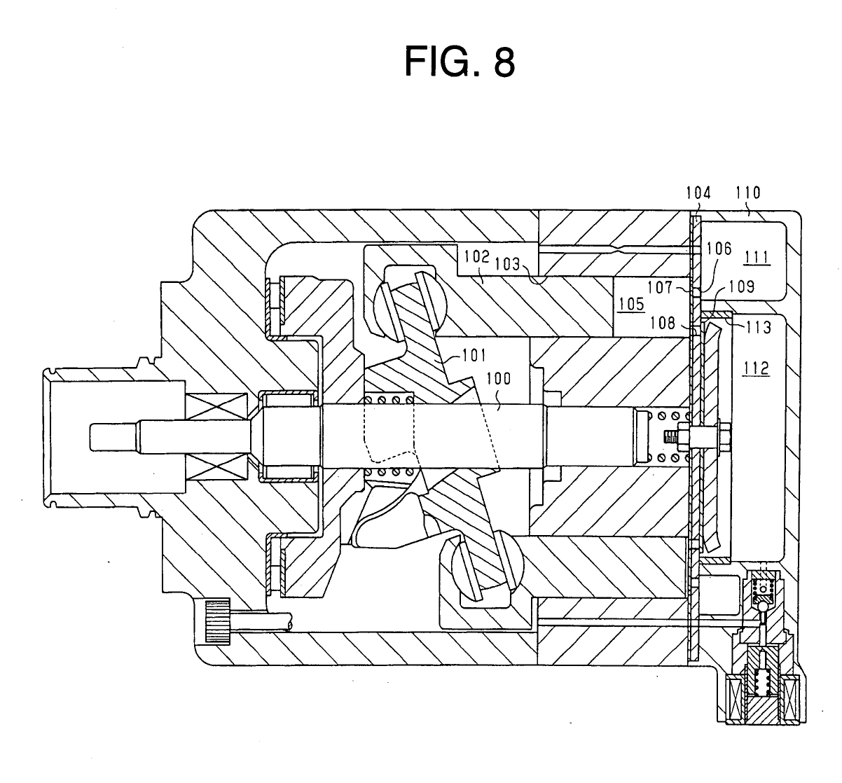

The present invention may be applied to a compressor that has a piston type compression mechanism as shown in FIG. 8. That is, in this compressor, as a rotary shaft 100 is driven by external power, a plurality of pistons 102 is reciprocated in respective cylinder bores 103 through a swash plate 101. Then, each piston 102 and a valve port assembly 104 define a compression chamber 105 in the cylinder bore 103 for compressing refrigerant gas. The valve port assembly 104 forms therein suction ports 106, suction valves made of flapper valves 107, discharge ports 108, and discharge valves made of flapper valves 109. A rear housing 110, which is connected to the valve port assembly 104 defines therein a suction chamber 111, with which each suction valve is capable of communication, and a discharge chamber 112, with which each discharge valve is capable of communication. The discharge chamber 112 is formed on the side of the rotary shaft 100 so as to face each compression chamber 105, and the suction chamber 111 is formed annularly on the outer peripheral side of the discharge chamber 112.

In a compressor having such a compression mechanism, a partition member 113 is provided to face an annular region (a predetermined region), that is, the valve port assembly 104 facing the discharge chamber 112 (a portion facing the discharge chamber in the compression mechanism) except the center thereof where the discharge valves are located (a specific region where a gas discharge port opens). The partition member 113 forms cylinder in shape, and is inserted into the discharge chamber 112 and supported therein. On the other hand, no sealing member for isolating in airtight the space between the annular region of the valve port assembly 104 and the partition member 113 from the discharge chamber 112 is provided between the partition member 113 and the valve port assembly 104. However, the clearance between the valve port assembly 104 and the partition member 113 is sufficiently small, so that the pressure of the refrigerant gas in the discharge chamber 112 is limited to be applied to the annular region of the valve port assembly 104.

In this case, since the partition member 113 controls the pressure of the refrigerant gas in the discharge chamber 112 to be applied to the annular region of the valve port assembly 104, the valve port assembly 104 substantially does not deform toward the compression chamber 105. Therefore, the communication between the discharge chamber 112 and the suction chamber 111 due to the deformation of the valve port assembly 104 is prevented, and the leakage of the refrigerant gas from the discharge chamber 112 to the suction chamber 111 is prevented, thereby preventing decrease in compression efficiency of the compression mechanism.

The present invention is not limited to be applied to a motor compressor for use in a vehicle air conditioner, but may, for example, be applied to a motor compressor for use in a domestic air conditioner.

The present invention is not limited to be applied to a motor compressor for use in an air conditioner, but may be applied to a refrigeration cycle other than the air conditioner, namely, a motor compressor for use in a refrigeration cycle for a refrigerator or a freezer.

The present invention is not limited to be applied to a motor compressor for use in a refrigeration cycle, but may, for example, be applied to a motor air compressor for use in an air-suspension system for a vehicle, or the like.

The present invention is not limited to be applied to a motor compressor, but may, for example, be applied to a scroll type compressor that is driven by a gasoline engine of a vehicle or a gas engine of a gas heat pump.

Therefore, the present examples and embodiments are to be considered as illustrative and not restrictive, and the invention is not to be limited to the details given herein but may be modified within the scope of the appended claims.

1. A compressor comprising:
a housing defining therein a discharge chamber;
a compression mechanism located adjacent to the discharge chamber in the housing; and
a partition member facing a predetermined region, which is a portion of the compression mechanism that faces the discharge chamber except a specific region where a gas discharge port opens, for restraining pressure of refrigerant gas in the discharge chamber to be applied to the predetermined region.

2. The compressor according to claim 1, wherein the partition member is made of a material that is different from the housing.

3. The compressor according to claim 2, wherein the partition member is metallic material and is in contact with the housing or the compression mechanism through a heat insulation material.

4. The compressor according to claim 3, wherein the partition member is made of iron.

5. The compressor according to claim 3, wherein the partition member is made of a material that has higher in strength than that of the housing.

6. The compressor according to claim 1, wherein the partition member is integrally composed of a disc-shaped partition wall, which faces the predetermined region, and a cylindrical peripheral wall, which extends from an outer periphery of the partition wall in an axial direction of the partition wall and is inserted and supported in the housing.

7. The compressor according to claim 6, further comprising:
a sealing member provided for isolating in airtight a space between the predetermined region and the partition member from the discharge chamber.

8. The compressor according to claim 7, wherein the sealing member includes a first sealing member, which is provided between the peripheral wall and the housing, and a second sealing member, which is provided between the partition wall and the compression mechanism.

9. The compressor according to claim 6, wherein the peripheral wall is supported on an inner peripheral surface of the housing through a heat insulation material.

10. The compressor according to claim 9, wherein the heat insulation material is an elastic material that absorbs vibration.

11. The compressor according to claim 6, further comprising:
an isolating member connected to the partition member for forming the discharge chamber to isolate the discharge chamber inside the housing; and
a communication means for connecting in airtight the discharge chamber to an outside of the housing.

12. The compressor according to claim 11, further comprising:
a heat insulation means for preventing heat transmission from the partition member to the compression mechanism.

13. The compressor according to claim 11, further comprising:
a heat insulation means for preventing heat transmission from the isolating member to the housing.

14. The compressor according to claim 13, wherein the heat insulation means is a clearance between the isolating member and the housing.

15. The compressor according to claim 6, wherein the housing includes a first housing component, in which the compression mechanism is located, and a second housing component, which defines therein the discharge chamber.

16. The compressor according to claim 15, wherein the partition member is held between the first housing component and the second housing component.

17. The compressor according to claim 6, wherein the compression mechanism is a scroll type and includes a fixed scroll member and a movable scroll member, the portion being a back surface of the fixed scroll member, the specific region being a center of the back surface of the fixed scroll member, the predetermined region being an annular region, that is, the back surface of the fixed scroll member except the center thereof.

18. The compressor according to claim 17, wherein the housing further defines a suction chamber, which is in communication with a space between the annular region and the partition member.

19. The compressor according to claim 1, wherein carbon dioxide is employed as the refrigerant gas.

20. The compressor according to claim 1, wherein the compression mechanism is a piston type and includes a valve port assembly, the portion being a back surface of the valve port assembly, the specific region being a center of the back surface, the predetermined region being an annular region, that is, the back surface except the center thereof.
